(19) United States
(12) Patent Application Publication
(10) Pub. No.: US 2009/0157429 A1
(43) Pub. Date: Jun. 18, 2009

(54) Health management system and method using mobile phone

(75) Inventors: Hyung Jik Lee, Daejeon (KR); Ki Ryong Ha, Daejeon (KR); Joon Young Jung, Daejeon (KR); Jeun Woo Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/155,834

(22) Filed: Jun. 10, 2008

(30) Foreign Application Priority Data
Dec. 13, 2007 (KR) 10-2007-0129725

(51) Int. Cl. G06Q 50/00

(52) U.S. Cl. 705/3

(57) ABSTRACT

A health care system using a mobile phone includes the mobile phone which has sensors attached thereto, stores a biological signal measured by the sensors, and transmits the stored biological signal during a phone call; and a health care server which receives the biological signals from the mobile phone, analyzes the received biological signal to extract a characteristic value, generates health condition information of a user based on the extracted characteristic value, and transmits the generated information to the mobile phone. Further, a health care method using a mobile phone includes determining whether a physical body comes into contact with the sensors; measuring the biological signal with the sensors when the physical body comes into contact with the sensors; extracting a characteristic value from the biological signal; transmitting the characteristic value to the server; and generating the health condition information to transmit it to the mobile phone.

### CROSS-REFERENCE(S) TO RELATED APPLICATIONS

The present invention claims priority of Korean Patent Application No. 10-2007-0129725, filed on Dec. 13, 2007, which is incorporated herein by reference.

### FIELD OF THE INVENTION

The present invention relates to a health care system and method using a mobile phone; and, more particularly, to a health care system and method capable of detecting a biological signal of a user by using sensors attached to a mobile phone, during a phone call, for transmitting the biological signal to a health care server, and for determining a health condition of the user.

### BACKGROUND OF THE INVENTION

As a conventional technology for measuring a biological signal, disclosed is that the biological signal is measured by a body having a plurality of electrodes and attached to a body of a testee.

Further, disclosed is that a health signal measuring apparatus is mounted on the button of a mobile phone, and thus a biological signal is automatically measured as a user brings the button into contact with his or her body.

In addition, disclosed is that the biological signal of a user is measured by that the user installs an electrocardiogram sensor and a heart pulse sensor at predetermined positions on the portable terminal so as to simultaneously measure the electrocardiogram and heart pulse of the user.

Because these conventional technologies measure the biological signal only when the user consciously intends to measure his or her biological signal, the biological signal of the user cannot be measured automatically while the mobile phone is used.

### SUMMARY OF THE INVENTION

It is, therefore, an primary object of the present invention to check whether or not a user is using a mobile phone, and unconsciously measure a biological signal of the user with sensors mounted in the mobile phone.

Another object of the present invention is to obtain the biological signal of the user using sensors mounted in the mobile phone during a phone call, then, to provide the biological signal to a health care server when the user finish the phone call, and to be provided with information about the health condition of the user based on the biological signal, so that it can provide the user with a health care service based on the biological signal in daily life anywhere and anytime.

In accordance with one aspect of the invention, there is provided a health care system using a mobile phone, including the mobile phone which is provided with a plurality of sensors are attached thereto, the sensors being driven when a phone call is started, stores a biological signal measured by the sensors, and transmits the stored biological signal when the phone call is finished; and a health care server which receives the biological signals from the mobile phone, analyzes the received biological signal to extract a characteristic value, generates information about a health condition of a user based on the extracted characteristic value, and transmits the generated information to the mobile phone.

Preferably, the mobile phone further includes a biological signal detecting unit for detecting whether or not the sensors come into contact with a physical body and generating a detection signal.

It is preferable that the mobile phone drives the sensors when the detection signal is generated.

The sensors may have at least one of an electrocardiogram (ECG) sensor, a photoplethysmogram (PPG) sensor, and a skin temperature (SKT) sensor.

Further preferably, the mobile phone further includes means for extracting the characteristic value of the user based on the stored biological signal when the phone call is finished and providing the extracted characteristic value for the health care server; and means for displaying the extracted characteristic value on a display unit.

The health care server may generate the information about the health condition of the user based on the extracted characteristic value.

The health care server may include a database for accumulatively storing the extracted characteristic value based on the received biological signal; a knowledge base for storing a living body information determination rule to which an opinion of a health care expert is reflected; and a reasoning unit for analyzing the extracted characteristic values based on the living body information determination rule stored in the knowledge base and generating the information about the health condition of the user.

Preferably, the reasoning unit analyzes the extracted characteristic values based on both the living body information determination rule stored in the knowledge base and the characteristic value stored in the database, and generates the information about the health condition of the user.

In accordance with another aspect of the invention, there is provided a health care method using a mobile phone, including determining whether or not a part of a physical body of a user comes into contact with a plurality of sensors mounted in the mobile phone when the user starts a phone call using the mobile phone; measuring a biological signal with the sensors when a result of the determining is that the part of the physical body comes into contact with the sensors; extracting a characteristic value based on the measured biological signal; transmitting the extracted characteristic value to a health care server; and generating information about a health condition of the user at the health care server based on the received characteristic value to transmit the generated information to the mobile phone.

The extracting the characteristic value may be conducted, after the biological signal has been measured with the sensors until the user finishes the phone call, and stored in a data storing unit.

Further, the transmitting the extracted characteristic value may include transmitting the detected biological signal to the health care server together with the characteristic value.

It is preferable that the health care method further includes storing the received characteristic value in a database; reasoning the information about the health condition of the user by analyzing the received characteristic value based on pre-stored living body information determination rule; and transmitting the information about the health condition of the user determined through the reasoning to the mobile phone of the user.

The reasoning the information may be performed by analyzing the received characteristic value based on past characteristic value pre-stored in the database and the pre-stored living body information determination rule.

In accordance with still another aspect of the present invention, there is provided a health care method using a mobile phone, including determining whether or not a part of a physical body of a user comes into contact with a plurality of sensors mounted in the mobile phone when the user starts a phone call using the mobile phone; measuring with the sensors and storing a biological signal when a result of the determining is that the part of the physical body comes into contact with the sensors; transmitting the stored biological signals to a health care server when the phone call is finished; extracting characteristic value using the received biological signal at the health care server; generating information about a health condition of the user based on the extracted characteristic value at the health care server to thereby transmit the generated information to the mobile phone.

The health care method may further include storing the extracted characteristic value in a database; reasoning the information about the health condition of the user by analyzing the extracted characteristic value based on pre-stored living body information determination rule; and transmitting the information about the health condition of the user determined through the reasoning, to the mobile phone of the user.

Further, the reasoning the information may be performed by analyzing the extracted characteristic value based on past characteristic value pre-stored in the database and the pre-stored living body information determination rule.

In the present invention, the biological signal is automatically measured using the sensors mounted in the mobile phone since the mobile phone starts a phone call and until the mobile phone finishes the phone call.

Further, while speaking over the mobile phone, the biological signal of the user is obtained using the sensors mounted in the mobile phone. Then, when the mobile phone finishes the phone call, the obtained biological signal is provided to the health care server. Thereby, the mobile phone receives the health condition information of the user based on the biological signal, so that it can provide the user with the health care service based on the biological signal in daily life anywhere and anytime.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a health care system using a mobile phone in accordance with an embodiment of the present invention;

FIGS. 2 and 3 illustrate examples in which sensors in accordance with an embodiment of the present invention are installed in a mobile phone;

FIG. 4 is a flow chart illustrating a process in which a mobile phone measures and transmits a biological signal in accordance with an embodiment of the present invention; and

FIG. 5 is a flow chart illustrating a process in which a health care server is operated in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art. The detailed descriptions of known functions and constructions that unnecessarily obscure the subject matter of the present invention will be avoided herein.

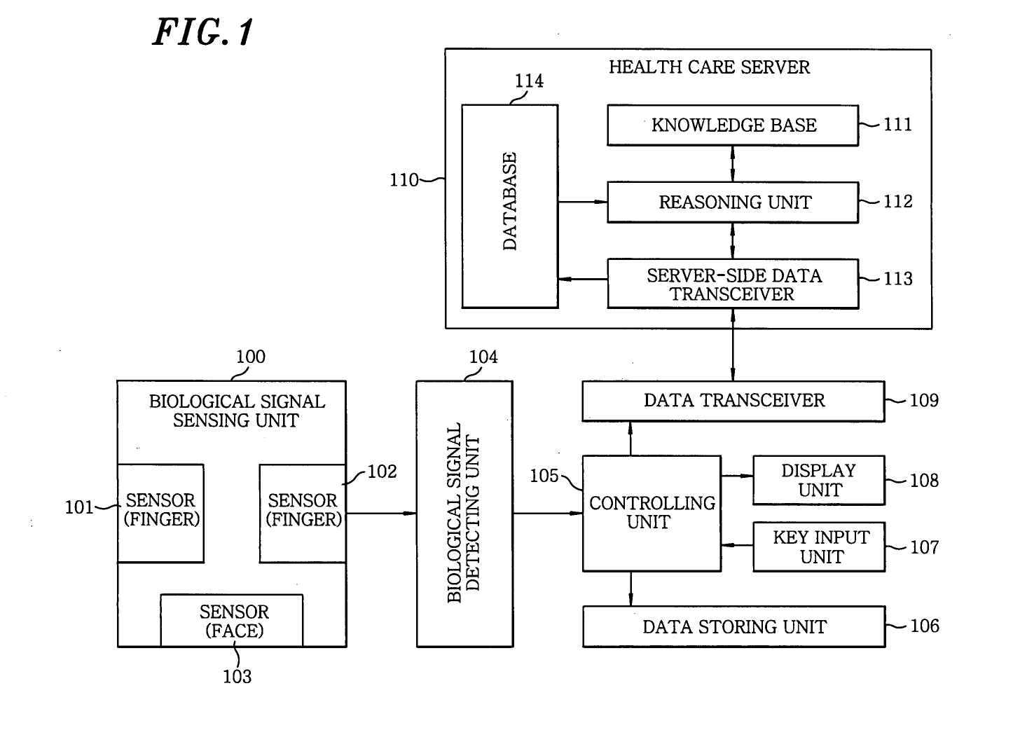

FIG. 1 is a block diagram illustrating a health care system using a mobile phone in accordance with an embodiment of the present invention.

Referring to FIG. 1, the health care system in accordance with the present invention includes a biological signal sensing unit 100 having a plurality of sensors 101, 102 and 103, a biological signal detecting unit 104, a controlling unit 105, a data storing unit 106, a key input unit 107, a display unit 108, a data transceiver 109, and a health care server 110. The health care server 110 has a knowledge base 111, a reasoning unit 112, a server-side data transceiver 113, and a database 114. Here, the biological signal sensing unit 100, biological signal detecting unit 104, controlling unit 105, data storing unit 106, key input unit 107, display unit 108, and data transceiver 109 are modularized and provided within a mobile phone.

In accordance with an embodiment of the present invention, the biological signal sensing unit 100 is installed in the mobile phone so as to be able to come into contact with a face and a finger of a user. For example, two electrocardiogram (ECG) sensors, one photoplethysmogram (PPG) sensor, and one skin temperature (SKT) sensor may be installed. Thus, the biological signals measured by the biological signal sensing unit 100 can have ECG waveforms, PPG waveforms, and SKT waveforms.

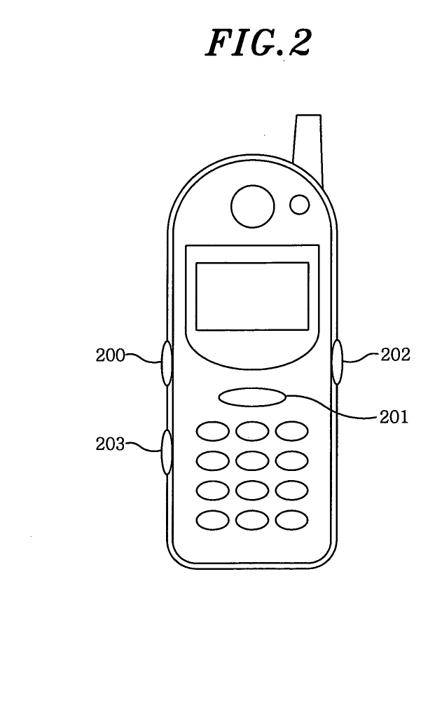

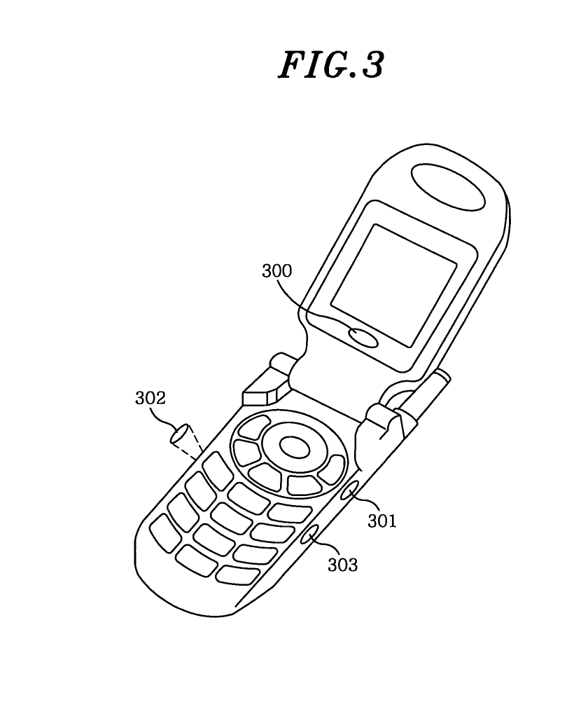

Examples in which the sensors of the biological signal sensing unit 100 are installed will be described with reference to FIGS. 2 and 3.

FIG. 2 illustrates one example in which sensors of the biological signal sensor unit 100 in accordance with an embodiment of the present invention are installed, and FIG. 3 illustrates another example in which sensors of the biological signal sensor unit 100 in accordance with an exemplary embodiment of the present invention are installed.

In FIG. 2, a position of each sensor is assigned in consideration of the places where the fingers of a user, who mainly speaks over a mobile phone using the right hand, are located. In other words, the ECG sensors 201 and 202 are located at places that come into contact with the right-hand thumb and face of the user, and the PPG sensor 200 is located at a place that comes into contact with the index or the middle finger of the user when the user speaks over the mobile phone. Typically, since the PPG signal is best detected from the index finger, the PPG sensor 200 is preferably located at the place that comes into contact with the index finger.

The SKT sensor 203 is located at a place that comes into contact with the middle or the medical finger of the user. The biological signal obtained through the SKT sensor 203 is the value of the skin temperature of the user. As such, the biological signal is preferably converted into the body temperature of the user using a correction algorithm, rather than being used as it is.

In FIG. 3, the position of each sensor is assigned in consideration of the places where the fingers of a user, who mainly speaks over a mobile phone using the left hand, are located. In other words, the ECG sensors 300 and 302 are located at places that come into contact with the left-hand thumb and face of the user, and the PPG sensor 301 is located at a place that comes into contact with the index or the middle finger of the user when the user speaks over the mobile phone. Further, the SKT sensor 303 is located at a place that comes into contact with the middle or medical finger of the user. in the case in which the sensors of the biological signal sensing unit 100 are installed in the mobile phone, when obtaining the ECG signal, better is the quality of the signal from the left-hand and the left cheek of the face, which are nearer the heart, than from the right-hand and the right cheek. For this reason, the example of FIG. 3 is preferable to that of FIG. 2.

The biological signal detecting unit 104 detects whether or not the sensors 101, 102 and 103 come into contact with the physical body on the basis of inputted signals through the biological signal sensing unit 100, and then provides a detection signal resulting from the detected result to the controlling unit 105. In other words, when the user attempts to speak over the mobile phone, the sensors 101, 102 and 103 come into contact with the physical body of the user, and thus the biological signal detecting unit 104 generates the detection signal to provide it to the controlling unit 105. Here, the biological signal detecting unit 104 may generate the detection signal when all of the sensors 101, 102 and 103 of the biological signal sensing unit 100 come into contact with the physical body of the user, and provide the controlling unit 105 with the biological signals measured by the sensors 101, 102 and 103.

As the user speaks over the mobile phone and the detection signal is inputted from the biological signal detecting unit 104 to the controlling unit, the controlling unit 105 generates a driving signal for driving the sensors 101, 102 and 103 of the biological signal sensing unit 100 to thereby drive the sensors 101, 102 and 103. Thus, the controlling unit 105 receives the biological signals, for instance, the waveform information, measured by the sensors 101, 102 and 103 from the biological signal detecting unit 104, and stores them in the data storing unit 106.

The controlling unit 105 recognizes that the phone call has ended, extracts characteristic values, for instance, those of a heart pulse, a stress level, a skin temperature, etc. on the basis of the biological signals stored in the data storing unit 106, and then displays the extracted results on the display unit 108 or transmits them to the health care server 110 through the data transceiver 109.

Meanwhile, the controlling unit 105 can recognize that the phone call has ended and transmit the biological signals stored in the data storing unit 106 to the health care server 110 through the data transceiver 109. Further, as the phone call is ended, the controlling unit 105 stops the driving of the sensors 101, 102 and 103 of the biological signal sensing unit 100.

In addition, after transmitting the biological signals or the characteristic values to the health care server 110, the controlling unit 105 receives information about the health condition of the user from the health care server 110, and displays this on the display unit 108.

The health care server 110 receives the biological signals or the characteristic values through the server-side data transceiver 113. Upon receiving the characteristic values, the health care server 110 stores them in the database 114. Upon receiving the biological signals, the health care server 110 extracts the characteristic values using the biological signals, and then stores the characteristic values in the database 114.

Further, the health care server 110 analyzes the received characteristic or extracted values comparing them with an expert's opinion pre-stored in the knowledge base 111, generates information about the current health condition of the user, and transmits the generated information to the mobile phone through the server-side data transceiver 114. Such a health condition information of the user can be transmitted to the mobile phone in the format of a short message service (SMS) message or a voice message.

The reasoning unit 112 extracts the characteristic values based on the received biological signals, performs reasoning about the health condition of the user through an analysis between the biological signal determination rules, where the expert's opinion pre-stored in the knowledge base 111 are reflected, and the received or extracted characteristic values, then generates the SMS message or the voice message on the basis of the determined results, and transmits it to the mobile phone.

Further, when determining the health condition of the user, the reasoning unit 112 checks whether or not the present characteristic values have changed on the basis of the past characteristic values of each user stored in the database 114, and can thereby generate the health condition information of the user.

Meanwhile, the reasoning unit 112 stores the characteristic values, which are extracted on the basis of the received biological signals, in the database 114.

The database 114 accumulatively stores the characteristic values of each user, which are used to check the health condition of the user.

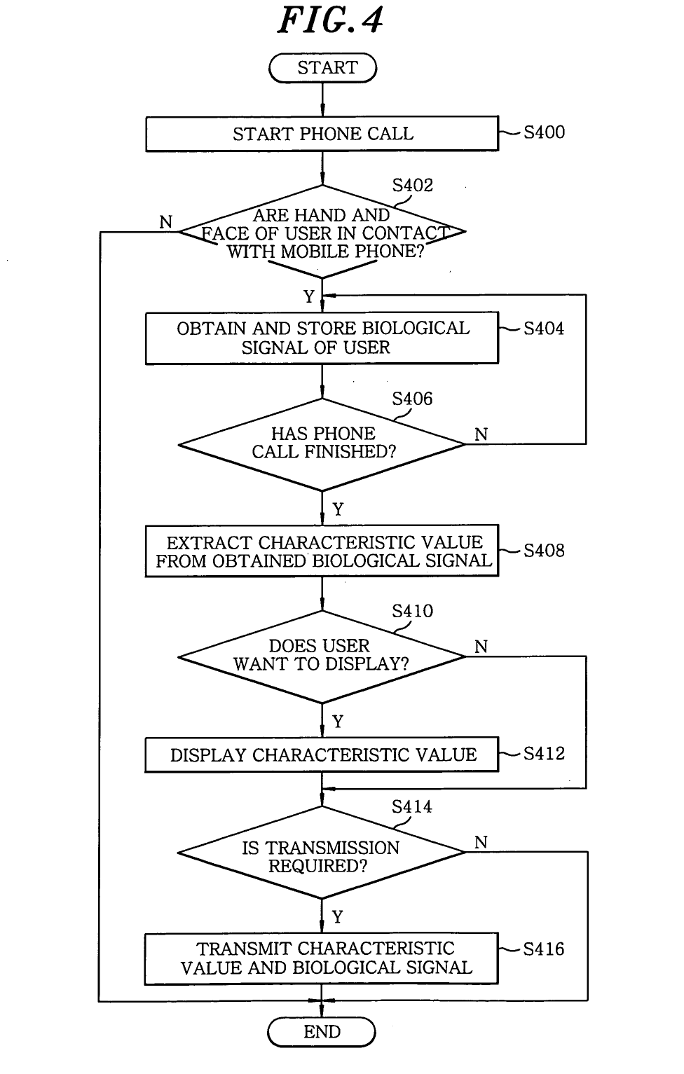

How the mobile phone is operated in the health care system having the aforementioned configuration will be described with reference to FIG. 4.

FIG. 4 is a flow chart illustrating the process in which a mobile phone measures and transmits a biological signal in accordance with an embodiment of the present invention.

Referring to FIG. 4, first, when a user starts a phone call (S400), the controlling unit 105 determines whether or not a detection signal has been received from the biological signal detecting unit 104 (S402). In other words, it is determined whether or not the sensors 101, 102 and 103 of the biological signal sensing unit 100 come into contact with the hand and the face of the user. When the sensors 101, 102 and 103 of the biological signal sensing unit 100 come into contact with the hand and the face of the user, the detection signal is generated by the biological signal detecting unit 104, and is inputted to the controlling unit 105.

As a result of the determination of step S402, the controlling unit 105 stores the biological signal measured by the sensors 101, 102 and 103 in the data storing unit 106 (S404).

Afterwards, the controlling unit 105 determines whether or not the user finishes the phone call (S406). As a result of the determination of step S406, when the user ends the phone call, the controlling unit 105 extracts characteristic values on the basis of the biological signals stored in the data storing unit 106 (S408).

On the other hand, when the user does not finish the phone call, the controlling unit 105 proceeds to step S404, continuing to store the biological signals received through the biological signal detecting unit 104 in the data storing unit 106.

Then, the controlling unit 105 determines whether or not a request is made to display the characteristic values on the basis of a key signal received from the key input unit 107 (S410).

As a result of the determination of step S410, when a request has been made to display the characteristic values, the controlling unit 105 displays the characteristic values through the display unit 108 (S412). When the user wants to transmit the characteristic values (S414), the controlling unit 105 transmits the characteristic values to the health care server 110 through the data transceiver 109 (S416).

Here, in step S416, the controlling unit 105 can transmit both the characteristic values and the biological signals stored in the data storing unit 106 to the health care server 110.

As a result of the determination of step S410, if it is determined that no request is made to display the characteristic values, the controlling unit 105 proceeds to step S414. As a result of the determination of step S414, if it is determined that the user does not make a request for the transmission, the process is terminated.

Although the exemplary embodiment of the present invention has been described as one example in which the controller determines the display and the transmission request of the user before performing the display and the transmission, the controller may obtain the characteristic values and the biological signals and transmit them to the health care server 110, on finishing the phone call. In addition, the controller may directly transmit the biological signals to the health care server 110 without extracting the characteristic values.

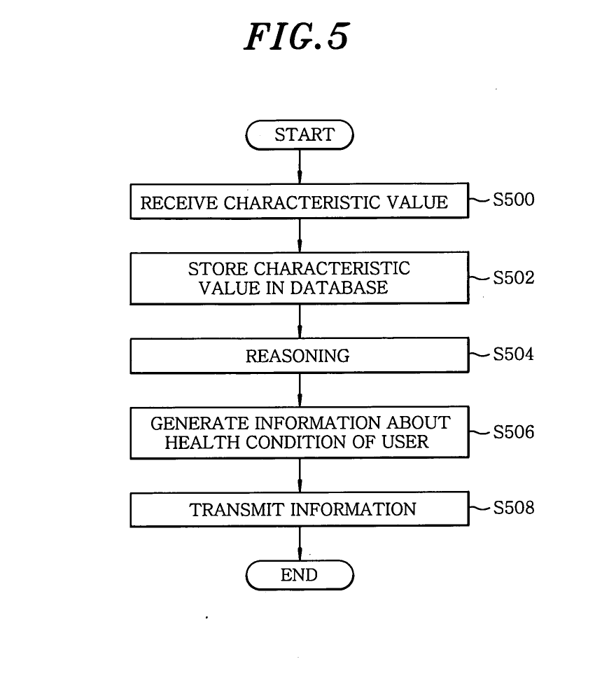

The processes of generating information about the health condition of the user on the basis of the characteristic values and the biological signals transmitted to the health care server 110 as described above and then transmitting the information to the mobile phone will be described with reference to FIG. 5.

FIG. 5 is a flow chart illustrating the process in which the health care server is operated in accordance with an embodiment of the present invention.

Referring to FIG. 5, the health care server 110 not only stores the characteristic values of the user, which are received through the server-side data transceiver 113, in the database 114, but also provides them to the reasoning unit 112 (S500 and S502).

The reasoning unit 112 performs reasoning about the health condition of the user based on the characteristic values and the living body information determination rules pre-stored in the knowledge base 111 (S504), generates information about the health condition of the user based on the health condition of the user determined through reasoning, and then transmits the generated information to the mobile phone through the server-side data transceiver 113 (S506 and S508). Meanwhile, when performing reasoning about the health condition of the user, the reasoning unit 112 can do so with reference to the past characteristic values of the user stored in the database 114.

Here, the health condition information of the user can be transmitted to the mobile phone in the format of an SMS message or a voice message.

Meanwhile, when the health care server 110 receives only the biological signals from the mobile phone, the reasoning unit 112 extracts the characteristic values based on the biological signals, and then performs steps S504, S506 and S508.

As is apparent from the above description, when the user speaks over a mobile phone, the biological signals are measured and stored using the sensors 101, 102 and 103 mounted in the mobile phone. The characteristic values of the user can be extracted on the basis of the biological signals stored when the user finished the phone call, and can then be transmitted to the health care server 110. Further, the user can be provided with the information about his or her own health condition from the health care server 110.

While the invention has been shown and described with respect to the embodiments, it will be understood by those skilled in the art that various changes and modifications may be made without departing from the scope of the invention as defined in the following claims.

What is claimed is:

1. A health care system using a mobile phone, comprising:
the mobile phone which is provided with a plurality of sensors are attached thereto, the sensors being driven when a phone call is started, stores a biological signal measured by the sensors, and transmits the stored biological signal when the phone call is finished; and
a health care server which receives the biological signals from the mobile phone, analyzes the received biological signal to extract a characteristic value, generates information about a health condition of a user based on the extracted characteristic value, and transmits the generated information to the mobile phone.

2. The health care system of claim 1, wherein the mobile phone further includes:
a biological signal detecting unit for detecting whether or not the sensors come into contact with a physical body and generating a detection signal.

3. The health care system of claim 2, wherein the mobile phone drives the sensors when the detection signal is generated.

4. The health care system of claim 1, wherein the sensors has:
at least one of an electrocardiogram (ECG) sensor, a photoplethysmogram (PPG) sensor, and a skin temperature (SKT) sensor.

5. The health care system of claim 1, wherein the mobile phone further includes:
means for extracting the characteristic value of the user based on the stored biological signal when the phone call is finished and providing the extracted characteristic value for the health care server; and
means for displaying the extracted characteristic value on a display unit.

6. The health care system of claim 5, wherein the health care server generates the information about the health condition of the user based on the extracted characteristic value.

7. The health care system of claim 1, wherein the health care server includes:
a database for accumulatively storing the extracted characteristic value based on the received biological signal;
a knowledge base for storing a living body information determination rule to which an opinion of a health care expert is reflected; and
a reasoning unit for analyzing the extracted characteristic values based on the living body information determination rule stored in the knowledge base and generating the information about the health condition of the user.

8. The health care system of claim 7, wherein the reasoning unit analyzes the extracted characteristic values based on both the living body information determination rule stored in the knowledge base and the characteristic value stored in the database, and generates the information about the health condition of the user.

9. A health care method using a mobile phone, comprising:
determining whether or not a part of a physical body of a user comes into contact with a plurality of sensors mounted in the mobile phone when the user starts a phone call using the mobile phone;
measuring a biological signal with the sensors when a result of the determining is that the part of the physical body comes into contact with the sensors;
extracting a characteristic value based on the measured biological signal;
transmitting the extracted characteristic value to a health care server; and
generating information about a health condition of the user at the health care server based on the received characteristic value to transmit the generated information to the mobile phone.

10. The health care method of claim 9, wherein the extracting the characteristic value is conducted, after the biological signal has been measured with the sensors until the user finishes the phone call and stored in a data storing unit.

11. The health care method of claim 9, wherein the transmitting the extracted characteristic value includes:
transmitting the detected biological signal to the health care server together with the characteristic value.

12. The health care method of claim 9, further comprising:
storing the received characteristic value in a database;
reasoning the information about the health condition of the user by analyzing the received characteristic value based on pre-stored living body information determination rule; and
transmitting the information about the health condition of the user, determined through the reasoning, to the mobile phone of the user.

13. The health care method of claim 12, wherein the reasoning the information is performed by analyzing the received characteristic value based on past characteristic value pre-stored in the database and the pre-stored living body information determination rule.

14. A health care method using a mobile phone, comprising:
determining whether or not a part of a physical body of a user comes into contact with a plurality of sensors mounted in the mobile phone when the user starts a phone call using the mobile phone;
measuring with the sensors and storing a biological signal when a result of the determining is that the part of the physical body comes into contact with the sensors;
transmitting the stored biological signals to a health care server when the phone call is finished;
extracting characteristic value using the received biological signal at the health care server;
generating information about a health condition of the user based on the extracted characteristic value at the health care server to thereby transmit the generated information to the mobile phone.

15. The health care method of claim 14, further comprising:
storing the extracted characteristic value in a database;
reasoning the information about the health condition of the user by analyzing the extracted characteristic value based on pre-stored living body information determination rule; and
transmitting the information about the health condition of the user, determined through the reasoning, to the mobile phone of the user.

16. The health care method of claim 15, wherein the reasoning the information is performed by analyzing the extracted characteristic value based on past characteristic value pre-stored in the database and the pre-stored living body information determination rule.
